(19) United States
(12) Patent Application Publication
(10) Pub. No.: US 2011/0204583 A1
(43) Pub. Date: Aug. 25, 2011

(54) Gasket Having Dual Bead Orientation On Rigid Carrier With Adjoining Gasket Material

(75) Inventor: Scott M. Anderson, Canton, MI (US)

(73) Assignee: FREUDENBERG-NOK GENERAL PARTNERSHIP, Plymouth, MI (US)

(21) Appl. No.: 12/711,655

(22) Filed: Feb. 24, 2010

(51) Int. Cl. F16J 15/06

(52) U.S. Cl. 277/628

(57) ABSTRACT

A gasket for engagement between a first adjoining structure and a second adjoining structure can include a rigid substrate, a first raised bead, a second raised bead, a first conformable member, and a second conformable member. The rigid substrate can have a generally uniform thickness and define a first major surface and a second major surface opposite the first major surface. The rigid substrate can include a support section. The first raised bead can be connected to the support section and protrude from the first major surface. The second raised bead can be connected to the support section and protrude from the second major surface and can be laterally spaced apart from the first raised bead. The first conformable member can be disposed on the first raised bead against the first major surface. The second conformable member can be disposed on the second raised bead against the second major surface.

### FIELD

The present disclosure relates to gaskets used to provide a seal between two adjoining structures, and more specifically to gaskets used to provide a seal between two adjoining structures having non-opposing mating surfaces.

### BACKGROUND

This section provides background information related to the present disclosure which is not necessarily prior art.

Gaskets can be used to provide a seal between two adjoining structures. A gasket can be placed between mating surfaces of the adjoining structures and compressed between the adjoining structures to form the seal. The gasket can fill the space between the mating surfaces and thereby prevent leakage of gas, fluid, or other similar medium between the mating surfaces. In typical applications, the mating surfaces of the adjoining structures directly oppose each other by overlapping each other. In other applications, the mating surface of one of the adjoining structures does not overlap the mating surface of the other adjoining structure in a region where a seal is to be formed.

### SUMMARY

This section provides a general summary of the disclosure, and is not a comprehensive disclosure of its full scope or all of its features.

The present disclosure provides a gasket for engagement between a first adjoining structure and a second adjoining structure. The gasket can include a rigid substrate, a first raised bead, a second raised bead, a first conformable member, and a second conformable member. The rigid substrate can have a generally uniform thickness and define a first major surface and a second major surface opposite the first major surface. The rigid substrate can include a support section. The first raised bead can be connected to the support section and protrude from the first major surface. The second raised bead can be connected to the support section and protrude from the second major surface and can be laterally spaced apart from the first raised bead. The first conformable member can be disposed on the first raised bead against the first major surface. The second conformable member can be disposed on the second raised bead against the second major surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of an exemplary gasket according to the principles of the present disclosure interposed between a first structure and a second structure;

FIG. 2 is a bottom view of the gasket of FIG. 1;

FIG. 3 is a cross-sectional view taken along line 3-3 of FIG. 1;

FIG. 4 is a partial cross-sectional view of the view taken along line 3-3 of FIG. 1;

FIG. 5 is a perspective view of a rigid substrate of the exemplary gasket of FIG. 1; and

FIGS. 6-12 are cross-sectional views of additional exemplary gaskets according to the principles of the present disclosure.

Corresponding reference numerals indicate corresponding parts throughout the several views of the drawings.

### DETAILED DESCRIPTION

Example embodiments will now be described more fully with reference to the accompanying drawings.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

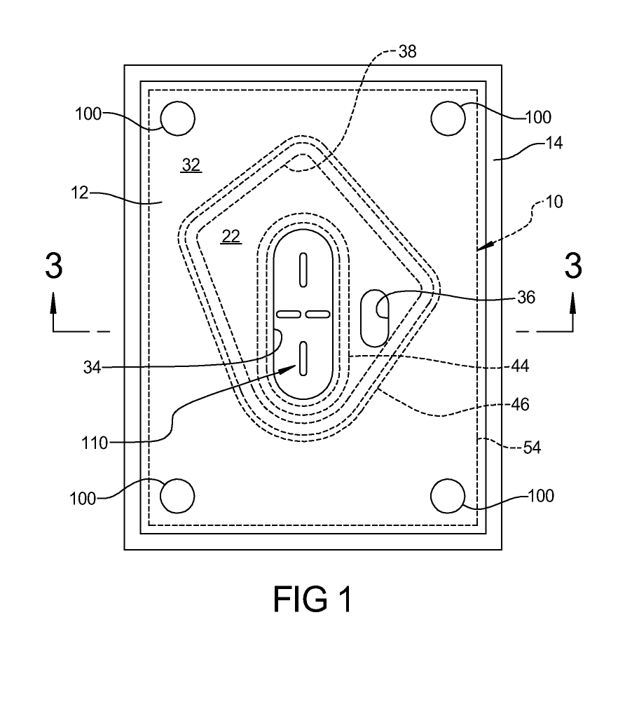

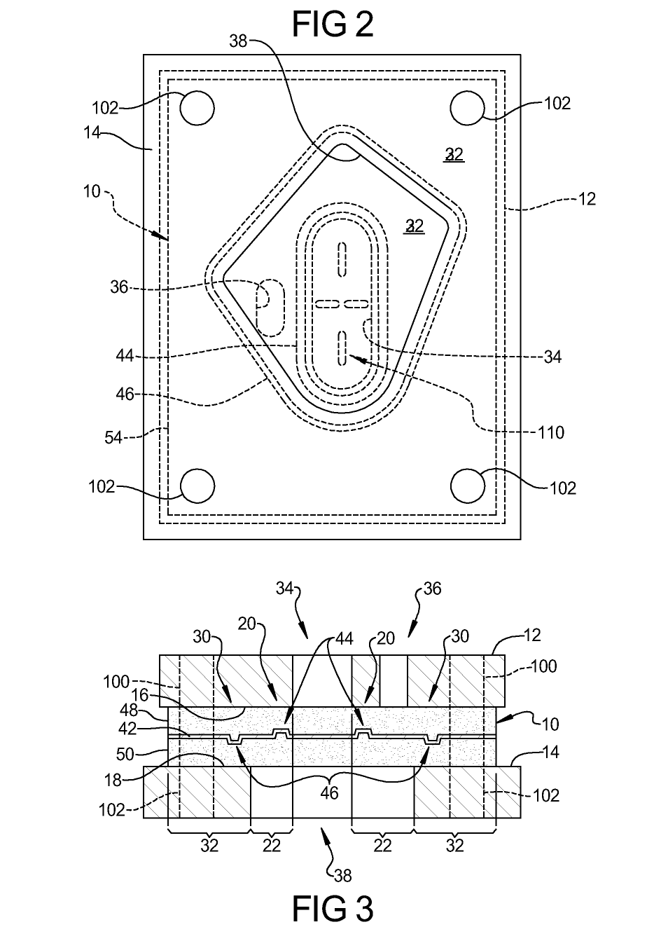

With reference to FIGS. 1-5, an exemplary gasket 10 according to the principles of the present disclosure is shown and will now be described. The gasket 10 can be located between and can engage a first component 12 and a second component 14. More specifically, the gasket 10 can be located between and can directly engage a first mating surface 16 of the first component 12 and a second mating surface 18 of the second component 14 that opposes the first mating surface 16.

The gasket 10 can form a first seal 20 between the gasket 10 and one of the first and second components 12, 14 in a first region 22 where portions of the first and second mating surfaces 16, 18 contacting the gasket 10 do not overlap (i.e., do not directly oppose). The gasket 10 can further form a second seal 30 between the first and second components 12, 14 in a second region 32 where the portions of the first and second mating surfaces 16, 18 contacting the gasket 10 do overlap (i.e., directly oppose). By forming the first and second seals 20, 30, the gasket 10 can be used to provide one or more seals between components, such as the first and second components 12, 14, having non-uniform geometries in regions where a seal is to be provided.

In the present example, the non-uniform geometry between the first and second components 12, 14 can result from an aperture 34 and an aperture 36 formed in the first component 12 and an aperture 38 formed in the second component 14. The apertures 34, 36, 38 provide the portions of the first and second mating surfaces 16, 18 contacting the gasket 10 with different opposing geometries. As discussed in further detail below, the first seal 20 can provide a first seal between the aperture 34 formed in the first component 12 and one or both the aperture 36 formed in the first component 12 and the aperture 38 formed in the second component 14. Additionally, the second seal 30 can provide a second seal between the apertures 34, 36 formed in the first component 12 and the aperture 38 formed in the second component 14.

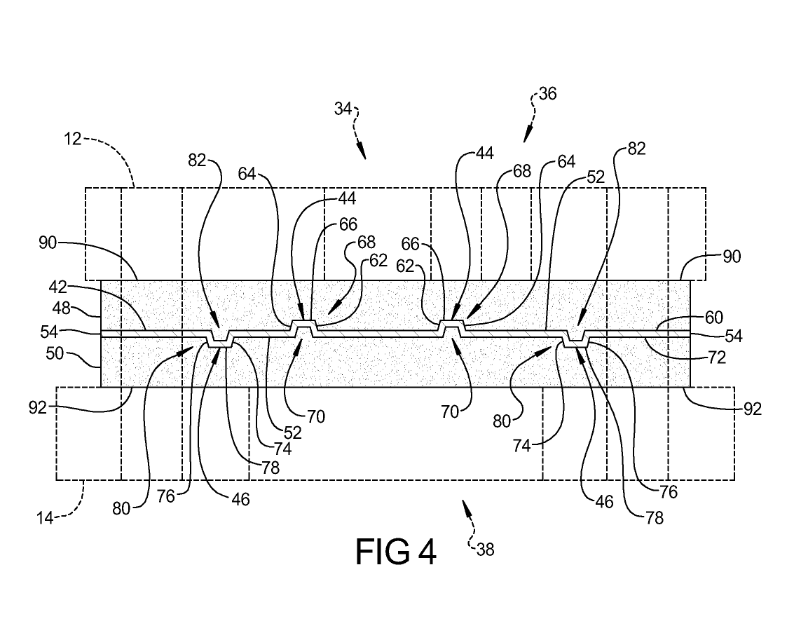

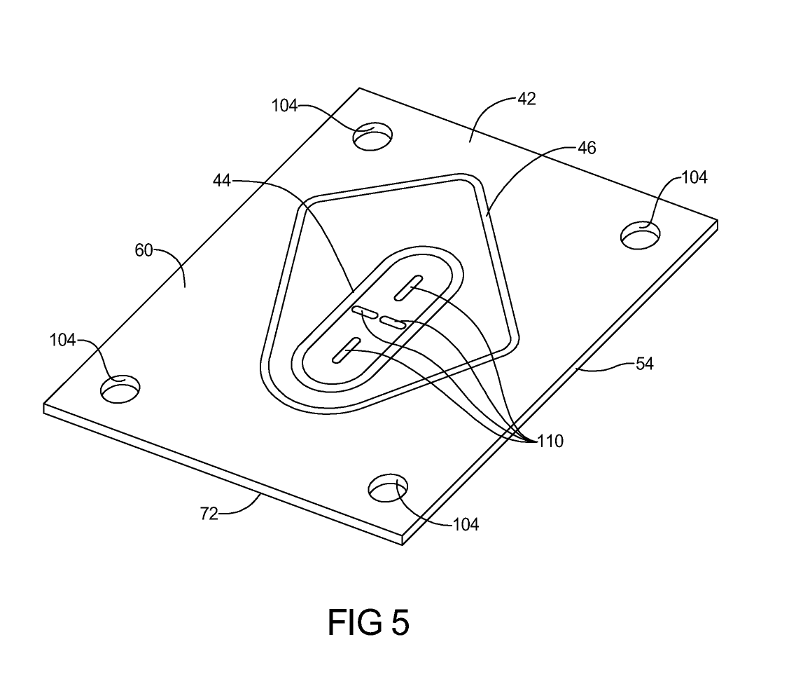

With particular reference to FIGS. 3 and 4, the gasket 10 can include a rigid substrate 42, a first raised bead 44, a second raised bead 46, a first conformable member 48, and a second conformable member 50. The rigid substrate 42 provides a stiffness feature of the gasket 10 that transfers compressive loads within the gasket 10 when compressed between the first and second components 12, 14. In particular, the rigid substrate 42 can transfer compressive loads between the first region 22 and the second region 32. By transferring the compressive loads, the rigid substrate 42 can improve the functional range of the first and second seals 20, 30.

The rigid substrate 42 can have a generally uniform thickness and can be formed from various materials including, but not limited to, metals such as steel or aluminum, plastics, and other similar materials. In various embodiments, the thickness can vary. In one example where the rigid substrate 42 is formed from a sheet of low carbon steel (e.g., 1008 or 1010 steel) or stainless steel (e.g., 300 series stainless steel), the thickness can be between 0.15 millimeters (mm) and 3.0 mm and, more particularly, can be approximately 0.8 mm.

The rigid substrate 42 can include a support section 52 extending between the first raised bead 44 and the second raised bead 46. The support section 52 can be generally planar in shape. The first raised bead 44 can be located in the first region 22 and can protrude from the generally planar support section 52 in a first direction. The second raised bead 46 can be laterally spaced apart from the first raised bead 44 and can be located in the second region 32. The second raised bead 46 can protrude from the support section 52 in a second direction opposite the first direction. The support section 52 and the first and second raised beads 44, 46 can cooperate to generate compressive force between the gasket 10 and the first component 12 in the first region 22 when the gasket 10 is compressed between the first and second components 12, 14 in the second region 32. The support section 52 can extend beyond the first and second raised beads 44, 46 and can define an outer extent 54 of the gasket 10.

The first and second raised beads 44, 46 can be formed integral with the support section 52. As one example, the rigid substrate 42 can be stamped from a solid sheet of steel or other metal and simultaneously formed to have the first and second raised beads 44, 46. As another example, the rigid substrate 42 can be molded from a plastic and simultaneously formed to have the first and second raised beads 44, 46. Alternately or additionally, one or both the first and second raised beads 44, 46 can be a rigid structure formed on the support section 52. As one example, one or both the first and second raised beads 44, 46 can be formed of a rigid coating applied to the support section 52 using a printing or a metal deposition method.

The first raised bead 44 can protrude from a first major surface 60 of the rigid substrate 42. The first raised bead 44 can include a pair of first sidewall segments 62, 64 and a first top wall segment 66 extending between the first sidewall segments 62, 64. The first raised bead 44 can define a first convex surface 68 on the first major surface 60 of the rigid substrate and can define a first concave surface 70 on a second major surface 72 of the rigid substrate 42 opposite the first major surface 60. It is understood that the first convex surface 68 is not limited to a particular shape or contour. In the present example, the first convex surface 68 can have a multi-faced, trapezoidal shape defined by the first top wall segment 66 and the first sidewall segments 62, 64, which can protrude from the first major surface 60 at an angle towards each other.

Depending on the geometries of the first and second components 12, 14 and a desired extent of the first seal 20, the first raised bead 44 can be a segmented bead or, alternatively, can be a continuous bead, such as in the present example. In the present example, the first raised bead 44 can be a continuous bead formed to surround the aperture 34.

The second raised bead 46 can protrude from the second major surface 72 and can include a pair of second sidewall segments 74, 76 and a second top wall segment 78 extending between the second sidewall segments 74, 76. The second raised bead 46 can define a second convex surface 80 on the second major surface 72 and a second concave surface 82 on the first major surface 60. The second convex surface 80 can be radially spaced apart from the first convex surface 68. The second convex surface 80, like the shape of the first convex surface 68, is not limited to a particular shape or contour and can have a shape or contour that is different than the shape or contour of the first convex surface 68. In the present example, the first and second convex surfaces 68, 80 are shown as having similar shapes for simplicity.

Depending on the geometries of the first and second components 12, 14 and a desired extent of the second seal 30, the second raised bead 46 may be a segmented bead or, alternatively, may be a continuous bead. In the present example, the second raised bead 46 can be a continuous bead formed to surround the aperture 38. The second raised bead 46 can be laterally spaced from the first raised bead 44.

The first conformable member 48 can be formed from various compressible materials, such as fiber compositions, elastomers, plastics, paper, and other similar materials. Generally, the first conformable member 48 can have a first stiffness (e.g., modulus of elasticity) less than a second stiffness of the rigid substrate 42. The first conformable member 48 can have a thickness of between 0.025 mm and 2.0 mm, and more particularly, approximately 0.8 mm.

The first conformable member 48 can, but need not be attached to the rigid substrate 42. The first conformable member 48 can be held against the rigid substrate 42 by compressive forces generated when the gasket 10 is compressed between the first and second components 12, 14. Alternately or additionally, the first conformable member 48 can be attached to the rigid substrate 42 by various methods including, but not limited to, using self-adhesive materials, adhesive bonding, mechanical fixation, spraying, printing, overmolding, or painting. The first conformable member 48 can be disposed against the first major surface 60 of the rigid substrate 42 and, more specifically, can be disposed on the first raised bead 44. Accordingly, the first conformable member 48 can be located between the first raised bead 44 and the first mating surface 16 of the first component 12 when the gasket 10 is positioned between the first and second components 12, 14.

The first conformable member 48 can include a first sealing surface 90 that can directly engage or cover the first mating surface 16. The first conformable member 48 can be formed on the entire first major surface 60, such as in the present example. Alternately, the first conformable member 48 can be formed (or located) only in one or both the first and second regions 22, 32 where the first and second seals 20, 30, respectively, are formed.

The second conformable member 50 can be formed from various compressible materials and can be formed of the same or a different material than the first conformable member 48. Generally, the second conformable member 50 can have a third stiffness less than the second stiffness of the rigid substrate 42. The second conformable member 50 can have a thickness of between 0.025 mm and 2.0 mm, and more particularly, approximately 0.8 mm. The third stiffness of the second conformable member 50 can be equal to or different than the first stiffness of the first conformable member 48.

The second conformable member 50 can be disposed against the second major surface 72 of the rigid substrate 42 and, more specifically, can be disposed on the second raised bead 46. Accordingly, the second conformable member 50 can be located between the second raised bead 46 and the second mating surface 18 of the second component 14 when the gasket 10 is positioned between the first and second components 12, 14.

The second conformable member 50 can, but need not be, attached to the rigid substrate 42. The second conformable member 50 can be held against or attached to the rigid substrate 42 by a method similar to or different than the method used to attach the first conformable member 48. The second conformable member 50 can include a second sealing surface 92 that can directly engage the second mating surface 18. The second conformable member 50 can be formed on the entire second major surface 72, such as in the present example. Alternately, the second conformable member 50 can be formed on (or located) only in the second regions 22, 32 where the second raised bead 46 is located and the second seal 30 is formed.

Compression of the gasket 10 between the first and second components 12, 14 can be achieved by conventional methods, such as a bolted connection. Accordingly, the first and second components 12, 14 can include a plurality of through holes 100, 102, respectively, that receive threaded bolts (not shown). In various configurations, the through holes may be provided in one or more of the rigid substrate 42, the first conformable member 48, and the second conformable member 50. The gasket 10 can also include a plurality of through holes 104 corresponding to the through holes 100, 102 through which the threaded bolts are received.

The through holes 100, 102, and 104 can serve as alignment features that are used to properly align the gasket 10 with the first and second components 12, 14. The through holes 104 can cooperate with adjoining portions of the rigid substrate 42 and thereby serve as attachment features that can be used to attach the gasket 10 to one or both the first and second components 12, 14. When attaching the gasket 10 to only one of the first and second components 12, 14, the portion of the rigid substrate 42 adjoining each of the through holes 104 can provide an area for forming a joint.

When the gasket 10 is aligned and compressed between the first and second components 12, 14, the first and second conformable members 48, 50 can provide conformable features that can directly engage and conform to the first and second mating surfaces 16, 18, including any irregularities that may be present on the surfaces. The second raised bead 46 can provide a first compression enhancing feature that increases contact stresses between the gasket 10 and the second mating surface 18. By increasing the contact stresses, the second raised bead 46 can improve the functional range of the second seal 30 formed in the second region 32 where the first and second mating surfaces 16, 18 directly oppose each other.

The first raised bead 44 can provide a second compression enhancing feature that increases contact stresses between the gasket 10 and the first mating surface 16. In particular, compressive forces applied to the gasket 10 by the first mating surface 16 are transferred through the first raised bead 44 and the support section 52 to the portion of the gasket 10 located in the second region 32 where the gasket 10 is supported by both the first and second components 12, 14. The transfer of the compressive forces results in bending stresses within the rigid substrate 42 that provide resistance to the compressive forces and thereby increase the contact stresses between the gasket 10 and the first mating surface 16 in the first region 22. By increasing the contact stresses, the first raised bead 44 can improve the functional range of the first seal 20 formed in the first region 22 where the first mating surface 16 does not directly oppose the second mating surface 18. Accordingly, the gasket 10 can improve the functional range of the first seal 20 formed between the apertures 34, 36 of the first component 12.

From the foregoing, it can be appreciated that the gasket 10 can improve the functional range of a gasket used to form a seal in a region where two adjoining components have non-opposing geometries. In the present example, the non-opposing geometry of the first and second components 12, 14 was the result of the apertures 34, 36 formed in the first component 12 and the aperture 38 formed in the second component 14. Non-opposing geometries can result from additional or other features formed in the mating surfaces of two adjoining components, such as channels. It is understood that the principles of the present disclosure can apply to other such geometries.

Additionally, while the gasket 10 can improve the functional range of seals formed between various features of two adjoining components, the gasket 10 can include additional features that provide communication between two or more features of the adjoining components. For example, the gasket 10 can include through holes 110 or other features that provide communication between the aperture 34 formed in the first component 12 and the aperture 38 formed in the second component 14, such as in the present example. Accordingly, it is further understood that the principles of the present disclosure can apply to gaskets used to form both seals and communication paths in a region where two adjoining components have non-opposing geometries.

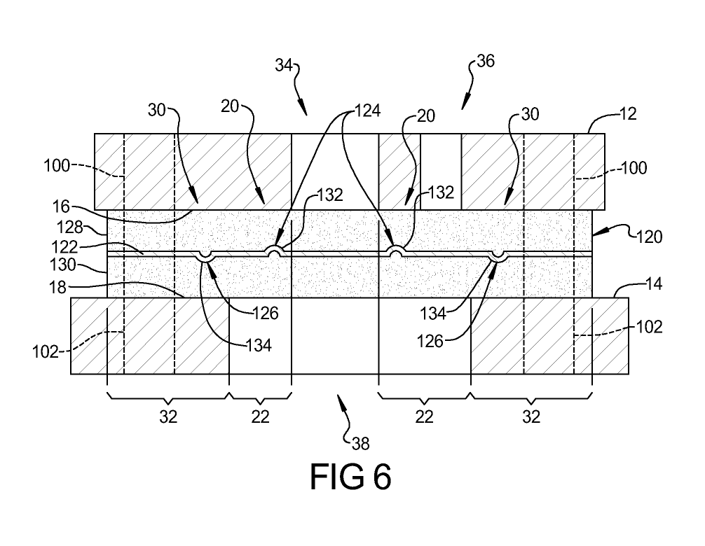

FIGS. 6-11 are cross-sectional views of additional exemplary gaskets according to the principles of the present disclosure. For the following description, it should be understood that the cross-sectional views of FIGS. 6-11 are similar to the cross-sectional view of FIG. 3. For brevity, the following description is limited to describing additional or different features with the understanding that the features of the gasket 10 described above can apply to the following examples.

With reference to FIG. 6, another exemplary gasket 120 can include a rigid substrate 122, a first raised bead 124, a second raised bead 126, a first conformable member 128, and a second conformable member 130. The gasket 120 is generally similar to the gasket 10, except that the first and second raised beads 124, 126 define curved first and second convex surfaces 132, 134 rather than the generally flat, multi-faced first and second convex surfaces 68, 80 defined by the first and second raised beads 44, 46 of the gasket 10. For simplicity, the first and second raised beads 124, 126 are shown as having similar shapes, however, it is understood that the first and second raised beads 124, 126 need not have similar shapes.

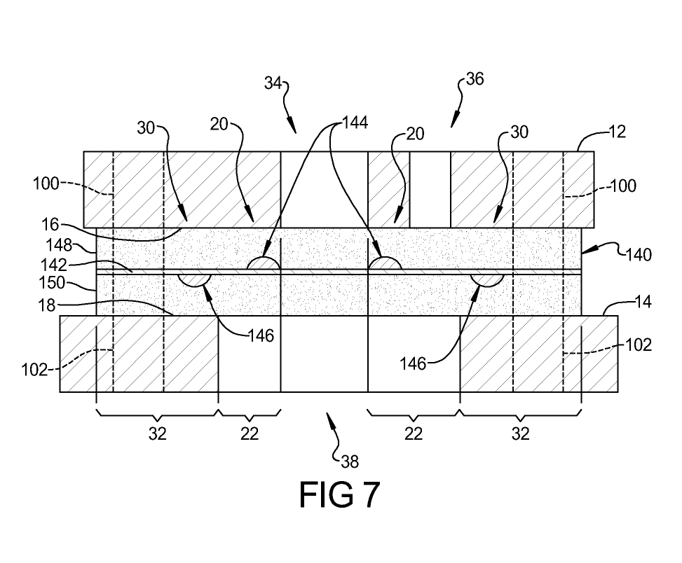

With reference to FIG. 7, another exemplary gasket 140 can include a rigid substrate 142, a first raised bead 144, a second raised bead 146, a first conformable member 148, and a second conformable member 150. The gasket 140 is generally similar to the gasket 10, except that the first and second raised beads 144, 146 are rigid beads formed on the rigid substrate 142 rather than integral with the rigid substrate 142. The rigid substrate 142 is a generally flat, thin member formed from a solid sheet of metal, plastic, or the like. As discussed above, the first and second raised beads 144, 146 can be formed of a rigid coating applied to the rigid substrate 142. The first and second raised beads 144, 146 can be formed of the same or different coatings. The first and second raised beads 144, 146 can have fourth and fifth stiffnesses, respectively, that are greater than sixth and seventh stiffnesses of the first and second conformable members 148, 150, respectively.

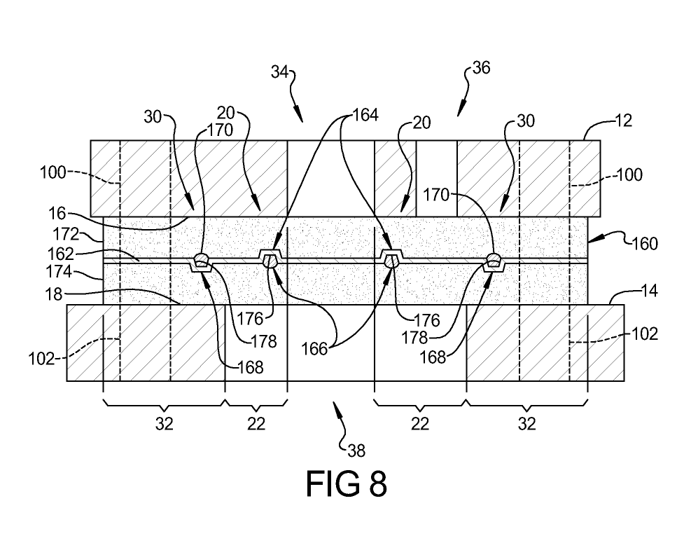

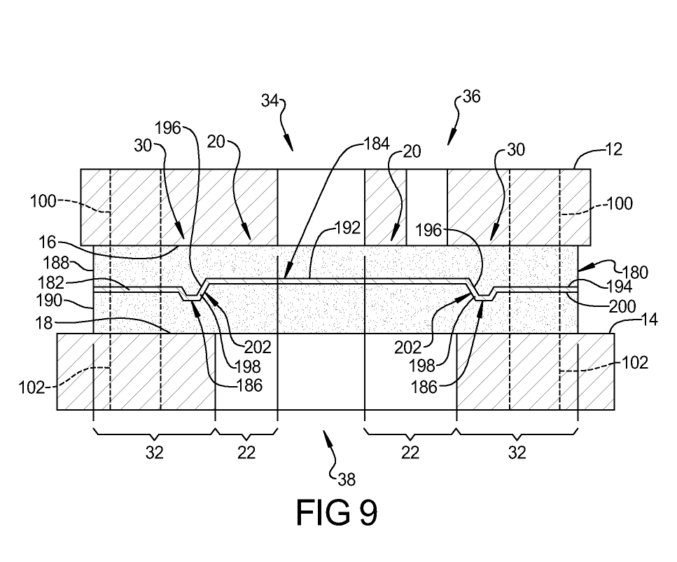

With reference to FIG. 8, another exemplary gasket 160 can include a rigid substrate 162, a first raised bead 164, a first filler component 166, a second raised bead 168, a second filler component 170, a first conformable member 172, and a second conformable member 174. The gasket 160 is generally similar to the gasket 10, except that the gasket 160 includes first and second filler components 166, 170 disposed between the first and second raised beads 164, 168 and the second and first conformable members 174, 172, respectively.

The first and second filler components 166, 170 can be formed to fill concavities 176, 178, respectively, defined by the first and second raised beads 164, 168. The first and second filler components 166, 170 can be formed of a coating formed on the first and second raised beads 164, 168. The first and second filler components 166, 170 can have eighth and ninth stiffnesses, respectively, that are greater than tenth and eleventh stiffnesses of the first and second conformable members 172, 174, respectively. The first and second filler components 166, 170 can provide additional stiffness to the first and second raised beads 164, 168. The first and second filler components 166, 170 can also be formed on and provide additional stiffness to portions of the rigid substrate 162 adjoining the first and second raised beads 164, 168.

With reference to FIG. 9, another exemplary gasket 180 can include a rigid substrate 182, a first raised bead 184, a second raised bead 186, a first conformable member 188, and a second conformable member 190. The gasket 180 is generally similar to the gasket 10, except that the first raised bead 184, rather than being a ring-shaped bead formed to surround the aperture 34 formed in the first component 12, is a raised bead having a broad top wall segment 192 formed to span the area of at least one of the apertures 34, 36 in plan view. In the present example, the top wall segment 192 can span the areas of both the apertures 34, 36.

The first raised bead 184 can protrude from a first major surface 194 of the rigid substrate 182 and include a first sidewall segment 196 extending between the top wall segment 192 and a second sidewall segment 198 of the second raised bead 186. The second raised bead 186 can protrude from a second major surface 200 of the rigid substrate opposite the first major surface 192 and can be formed to surround the first raised bead 184. Together, the first and second sidewall segments 196, 198 can form a support section 202 of the rigid substrate 182 extending between the first and second raised beads 184, 186.

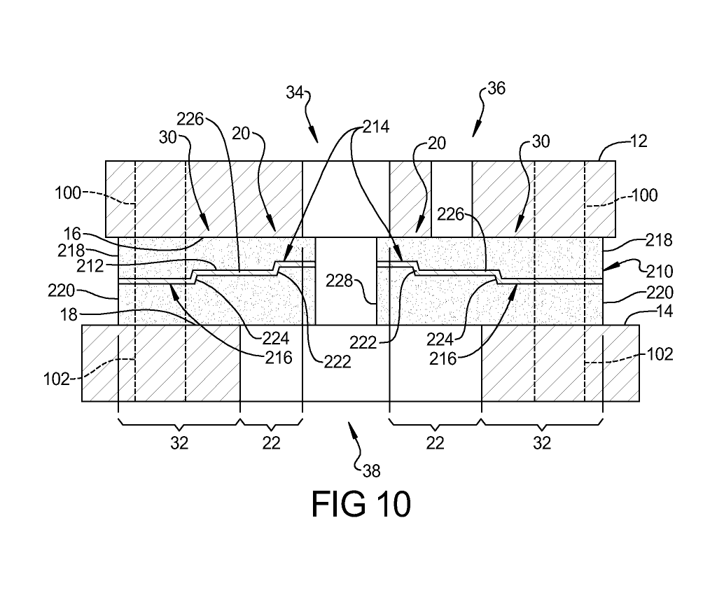

With reference to FIG. 10, another exemplary gasket 210 can include a rigid substrate 212, a first raised bead 214, a second raised bead 216, a first conformable member 218, and a second conformable member 220. The gasket 210 is generally similar to the gasket 10, except that the first raised bead 214 includes a single sidewall segment 222 extending from the rigid substrate 212, rather than the pair of sidewall segments 62, 64. Similarly, the second raised beads 216 include a single sidewall segment 224 extending from the rigid substrate 212, rather than a pair of sidewall segments 74, 76.

The rigid substrate 212 includes a support section 226 extending between the sidewall segments 222, 224. The first and second raised beads 214, 216 can be connected to the rigid substrate 212 by only the single sidewall segments 222, 224 connected to the support section 226. In the present example, the gasket 210 further includes an aperture 228 extending through the first conformable member 218, the first raised bead 214, and the second conformable member 220. The aperture 228 provides communication between the aperture 34 formed in the first component 12 and the aperture 38 formed in the second component 14. The gasket 210 provides the first and second seals 20, 30 that inhibit communication between the aperture 36 formed in the first component 12 and both the aperture 34 formed in the first component 12 and the aperture 38 formed in the second component 14.

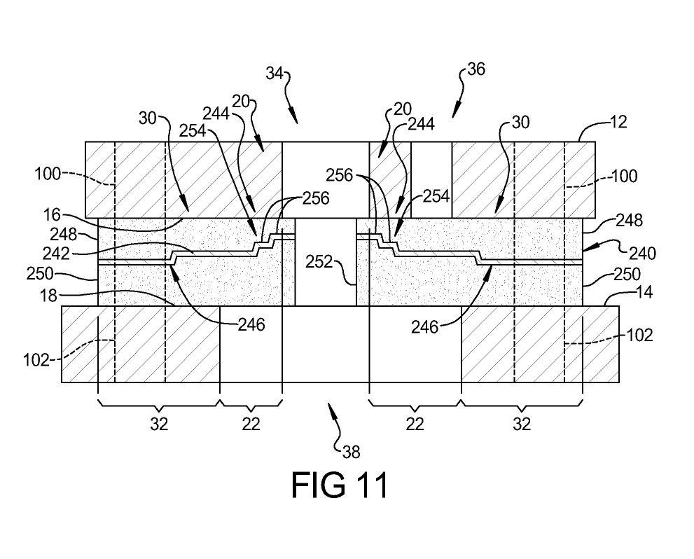

With reference to FIG. 11, another exemplary gasket 240 can include a rigid substrate 242, a first raised bead 244, a second raised bead 246, a first conformable member 248, a second conformable member 250, and an aperture 252. The gasket 240 is generally similar to the gasket 210, except that the first raised bead 244 includes a single, stepped sidewall segment 254 defining lateral surfaces 256. The lateral surfaces 256 may provide a compression enhancing feature that varies the contact stresses between the gasket 10 and the first mating surface 16. Although not specifically shown, the second raised bead 246 can include sidewall segments that are stepped in a manner similar to the stepped sidewall segment 254.

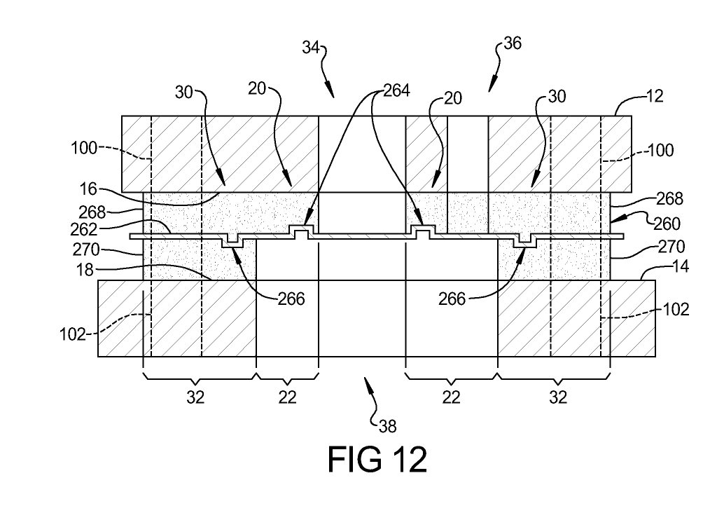

With reference to FIG. 12, another exemplary gasket 260 can include a rigid substrate 262, a first raised bead 264, a second raised bead 266, a first conformable member 268, a second conformable member 270. The gasket 260 is generally similar to the gasket 10, except that the first and second conformable members 268, 270 are disposed only in areas where the gasket 260 can engage the first and second mating surfaces 16, 18. In other words, the first and second conformable members 268, 270 may not be disposed in areas where features in the first and second components 12, 14, such as the apertures 34, 36, 38, create a gap or other irregularity in the first and second mating surfaces 16, 18 that cannot be conformed to. In configurations such as the present example, portions of the rigid substrate 262 can be exposed to the apertures 34, 36, 38. It is understood that the first and second conformable members 268, 270 can have different geometries that complement the geometries of the first and second components 12, 14.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A gasket for engagement between a first adjoining structure and a second adjoining structure, the gasket comprising:
a rigid substrate having a generally uniform thickness and defining a first major surface and a second major surface opposite said first major surface, said rigid substrate including a support section;
a first raised bead connected to said support section and protruding from said first major surface;
a second raised bead connected to said support section and protruding from said second major surface, said second raised bead being laterally spaced apart from said first raised bead;
a first conformable member disposed on said first raised bead against said first major surface; and
a second conformable member disposed on said second raised bead against said second major surface.

2. The gasket according to claim 1, wherein said first raised bead includes a first convex surface protruding from said first major surface.

3. The gasket according to claim 2, wherein said second raised bead includes a second convex surface protruding from said second major surface and radially spaced apart from said first convex surface.

4. The gasket according to claim 1, wherein said first and second raised beads are formed integral with said support section.

5. The gasket according to claim 1, wherein said first raised bead is located in a first region of said gasket where said gasket is adapted to engage only a first mating surface of said first adjoining structure, and said second raised bead is located in a second region of said gasket where said gasket is adapted to engage both said first mating surface and an opposing second mating surface of said second adjoining structure.

6. The gasket according to claim 5, wherein said first conformable member is adapted to engage said first mating surface in both said first and second regions.

7. The gasket according to claim 5, wherein said first conformable member is adapted to engage said first mating surface in only said first region.

8. The gasket according to claim 5, wherein said second conformable member is adapted to engage said second mating surface in only said second region.

9. The gasket according to claim 1, wherein in a first region, said gasket is adapted to engage only an opposing first mating surface of said first adjoining structure, and in a second region, said gasket is adapted to engage both said first mating surface and an opposing second mating surface of said second adjoining structure, and wherein said second conformable member is adapted to engage said second mating surface in only said second region.

10. The gasket according to claim 9, wherein said first raised bead is located in said first region and said second raised bead is located in said second region.

11. The gasket according to claim 9, wherein said first conformable member is adapted to engage said first mating surface in both said first and second regions.

12. The gasket according to claim 11, wherein said first raised bead is located in said first region and said second raised bead is located in said second region.

13. The gasket according to claim 9, wherein said first conformable member is adapted to engage said first mating surface in only said first region.

14. The gasket according to claim 13, wherein said first raised bead is located in said first region and said second raised bead is located in said second region.

15. The gasket according to claim 1, wherein said first conformable member is disposed on said support section against said first major surface.

16. The gasket according to claim 1, wherein said first conformable member is disposed on said second raised bead against said first major surface.

17. The gasket according to claim 1, wherein said first conformable member is attached to said rigid substrate.

18. The gasket according to claim 17, wherein said second conformable member is attached to said rigid substrate.

19. The gasket according to claim 1, wherein said rigid substrate includes an alignment feature for aligning said rigid substrate with at least one of said first adjoining structure and said second adjoining structure.

20. The gasket according to claim 1, wherein said rigid substrate includes an attachment feature for attaching said rigid substrate to at least one of said first adjoining structure and said second adjoining structure.

21. The gasket according to claim 1, wherein one of said first and second raised beads is connected to said rigid substrate by only a single sidewall segment connected to said support section.

22. The gasket according to claim 1, wherein one of said first and second raised beads includes a top wall segment radially spaced apart from said support section and a stepped sidewall segment extending between said top wall segment and said support section.
